(19) United States
(12) Patent Application Publication
(10) Pub. No.: US 2009/0309027 A1
(43) Pub. Date: Dec. 17, 2009

(54) RF Detector and Temperature Sensor

(75) Inventor: Mark Alan Von Striver, Folsom, CA (US)

Correspondence Address: DLA PIPER LLP (US ), 2000 UNIVERSITY AVENUE, EAST PALO ALTO, CA, 94303-2248, US

(73) Assignee: Aleph America, Reno, NV (US)

(21) Appl. No.: 12/539,561

(22) Filed: Aug. 11, 2009

Related U.S. Application Data
(62) Division of application No. 11/824,402, filed on Jun. 28, 2007.

(51) Int. Cl. G01J 5/20

(52) U.S. Cl. 250/338.3; 250/340

(57) ABSTRACT

An RF electromagnetic radiation detector has a device that has a first terminal and a second terminal with a PN junction therebetween. The first terminal is connected to the P side of the PN junction and the second terminal is connected to the N side of the PN junction, with the device susceptible to a voltage being built across the PN junction in the presence of RF electromagnetic radiation. The detector is first reverse biased by connecting a first voltage to the first terminal and a second voltage, higher than the first voltage to the second terminal. Current is then measured from the second terminal, where the current measured is indicative of the presence of RF electromagnetic radiation. A temperature sensor has a load, that has a first terminal and a second terminal with the first terminal connectable to a first voltage. A capacitor has a third terminal and a fourth terminal with the third terminal connected to the second terminal and the fourth terminal connectable to a second voltage. The first terminal is connected to the first voltage and the fourth terminal is connected to the second voltage. Finally the first voltage is disconnected from the first terminal and the second voltage from the fourth terminal, and the voltage at the third terminal is measured. The voltage measured at the third terminal or the amount of time required for the voltage at the third terminal to reach a threshold voltage, is dependent upon the ambient temperature.

### CROSS REFERENCE TO RELATED APPLICATIONS

This application is a divisional of U.S. application Ser. No. 11/824,402, filed Jun. 28, 2007, the entire contents of which is incorporated herein by reference.

### TECHNICAL FIELD

The present invention relates to a circuit that can detect Radio Frequency (RF) electromagnetic radiation, which is detrimental for an intrusion detection device, and a circuit for sensing ambient temperature that can be used to adjust the sensitivity of an infrared sensor in an intrusions detection device.

### BACKGROUND OF THE INVENTION

Intrusion detection devices are well known in the art. One type is a passive infrared intrusion detection device in which an infrared sensor detects the heat (infrared radiation) from a human intruder and generates an alarm signal in response thereto. Circuits to process an alarm signal generated by an infrared sensor include an amplifier or other means of system gain to amplify the signal from the infrared sensor. Typically however, a sensor amplifier in the presence of RF radiation can cause the spurious generation of an amplified signal (i.e. an amplified signal is generated by the sensor amplifier in the absence of a signal from the infrared sensor) thereby generating a false alarm signal. Thus, there is the need to detect when the intrusion detection device is subject to RF radiation and to take measures to prevent the generation of false alarm signal by lowering gain (or sensitivity) or refusing to assert an alarm signal when RF is detected.

Another problem associated with passive infrared intrusion detection devices is that the infrared sensor detects infrared radiation (heat) generated by the human intruder. However, the sensor needs to distinguish between the heat generated by an intruder versus the ambient temperature (background). As the ambient temperature approaches target temperature, it becomes increasingly difficult to distinguish the two, and thus, the sensitivity of the infrared sensor must be increased. On the other hand, it is not desired to have too high of a sensitivity for the infrared sensor, as that may cause the generation of a false alarm signal. Thus, it is desirable to be able to measure ambient temperature.

### SUMMARY OF THE INVENTION

An RF electromagnetic radiation detector comprises a device having a first terminal and a second terminal with a PN junction therebetween. The first terminal is connected to the P side of the PN junction and the second terminal is connected to the N side of the PN junction, with the device susceptible to a voltage being built across the PN junction in the presence of RF electromagnetic radiation. The detector has means for reverse biasing the device by connecting a first voltage to the first terminal and a second voltage, higher than the first voltage to the second terminal. The detector further has means for measuring the current from the second terminal, wherein the current measured is indicative of the presence of RF electromagnetic radiation.

A temperature sensor comprises a load, that has a first terminal and a second terminal with the first terminal connectable to a first voltage. A capacitor has a third terminal and a fourth terminal with the third terminal connected to the second terminal and the fourth terminal connectable to a second voltage. The sensor further has means for connecting the third terminal to the second voltage. Finally, the sensor has means for disconnecting the second voltage from the third terminal and for measuring the voltage at the third terminal. The time for the voltage measured at the third terminal to reach a target voltage is dependent upon the ambient temperature.

### BRIEF DESCRIPTION OF THE DRAWINGS

FIG. 1 is a circuit diagram of an RF electromagnetic radiation detector of the present invention.

FIG. 2 is a graph of the voltage presented to the microcontroller shown in FIG. 1 as a function of time, in the presence and absence of RF electromagnetic radiation.

FIG. 3 is a circuit diagram of a temperature sensor of the present invention, used to adjust the sensitivity of a passive infrared sensor.

FIG. 4 is a graph of the capacitance change as a function of temperature referring to the circuit in FIG. 3. The capacitance change shown is typical of a capacitor with a dielectric type Y5V. Other dielectrics can also be used with different capacitance versus temperature characteristics.

FIG. 5 is a graph of the voltage presented to the microcontroller shown in FIG. 3 as a function of time at two different temperatures using the example dielectric type Y5V.

### DETAILED DESCRIPTION OF THE INVENTION

Referring to FIG. 1 there is shown a circuit diagram of an RF electromagnetic radiation detector 10 of the present invention. The detector 10 comprises a microcontroller 12 having a first node A and a second node B. A resistor 20 having two ends is connected between node A and node 30. A diode 22 connects between node 30 and node 16 , which is connected to node B of the microcontroller 12. The resistor 20 is optional, and is used to act as a current limit resistor when the diode 22 is an LED and is also used as a display device in the forward bias mode. The diode 22 has a cathode and an anode, with the anode connected to node 30 and the cathode connected to node 16. As is well known, the diode 22 has a PN junction. Thus, the anode connected to node 30 is connected inside of the diode 22 to the P side of the PN junction. The cathode is connected to node 16 and is connected inside of the diode 22 to the N side of the PN junction. The node 16 is connected to Node B of the microcontroller 12. A capacitor 40 has two ends, with one end connected to node 16 or node B of the microcontroller 12, and the other end connected to ground.

In the operation of the detector 10, the microcontroller 12 connects node A to a first voltage (i.e. ground) and node B to a second voltage (i.e. Vcc), with the second voltage higher than the first voltage, thereby reverse biasing the diode 22 and the PN junction therein. This action also charges the capacitor 40 to the second voltage. Thereafter, the node A is held at the lower voltage by the microcontroller 12 while the pin connected to node B is changed from an output to a high impedance input with a means of measuring the voltage on the pin connected to node B. The time it takes for the capacitor 40 to discharge (measured at node B) to a predetermined voltage threshold is measured by the microcontroller 12. The time to discharge capacitor 40 to a fixed threshold varies with the amount of leakage current allowed by the diode 22 plus any current generated by the diode 22 by means of rectifying RF energy impinging on the diode 22. Thus, the amount of time it takes to discharge capacitor 40 to a fixed threshold can be compared to the amount of time that is expected under a known condition of no RF electromagnetic radiation impinging on the detector 10.

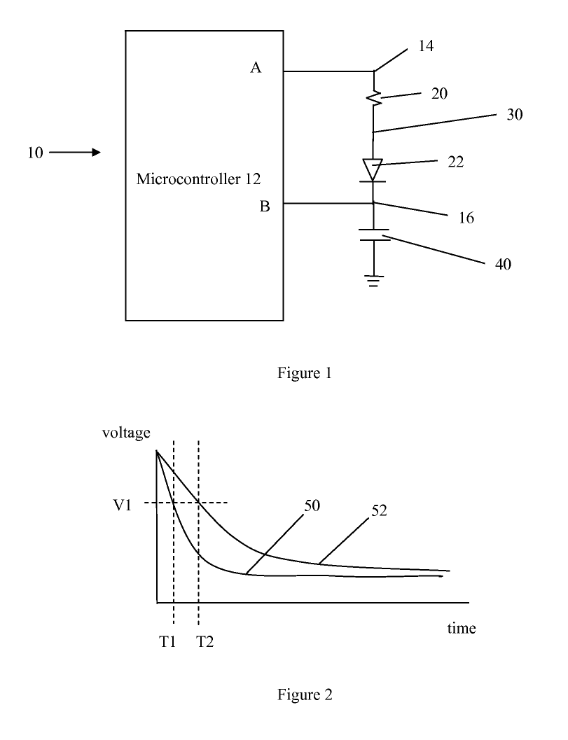

The basis for these two measurement theories can be seen by referring to FIG. 2. In FIG. 2 graph 50 represents the amount of time it takes for Node B to discharge in the presence of RF radiation detector 10. Graph 52 represents the time to discharge in the absence of RF radiation impinging on the detector 10. As can be seen, if the time it takes to discharge capacitor 40 (T1) is less than the time expected in the absence of RF radiation impinging on the detector (T2), this indicates that RF radiation has been detected. The theory of operation is as follows. The diode 22 can be any device including but not limited to a Light Emitting Diode (LED), schottky diode, pin diode, or base-emitter junction of a bipolar transistor, or a parasitic diode of a MOSFET device, that has a PN junction such that the PN junction is susceptible to a voltage being built across the PN junction in the presence of RF electromagnetic radiation, thereby causing a rectification of the RF signal, increasing the current output of the diode 22. This increase in current can be indirectly measured by the microcontroller 12 at node B, by measuring the time it takes for the current to discharge capacitor 40 to a fixed voltage threshold. The resistor 20 is an optional circuit element, provided to limit current to the LED 22 in the emission (indicator) mode of operation. It is not strictly necessary if the circuit is to be used only to detect RF. Finally, the capacitor 40 is another optional circuit element. The capacitor 40 is used to establish the amount of time it takes for the detected RF radiation to charge (or discharge) to a threshold. If the capacitance on the pin in the microcontroller 12 and the capacitance on the wires, and other stray capacitance is sufficient, then the capacitor 40 is also not needed. Thus, the capacitor 40 is added, only to extend the discharge time such that the measurement of the current flow can be accurately resolved.

As discussed hereinabove, once RF electromagnetic radiation is detected, the intrusion detection device can be desensitized or “turned off”, i.e. the alarm signal output is disabled until RF radiation is no longer detected. This prevents the output of false alarm signals.

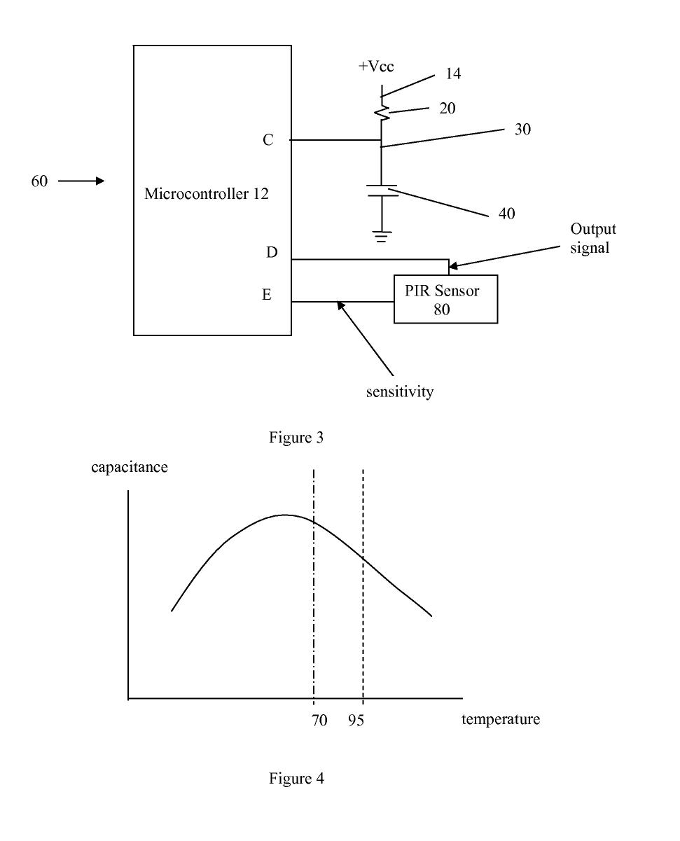

Referring to FIG. 3 there is shown a temperature sensor 60 of the present invention. The temperature sensor 60 has many elements similar to the RF detector 10 shown in FIG. 1 and thus the same numerals will be used to describe the same elements. The temperature sensor 60 comprises a microcontroller 12, having a third node C, a fourth node D and a fifth node E. As is well known to one of ordinary skilled in the art, some of the nodes C, D and E can be the same nodes A and B shown in FIG. 1. The sensor 60 further comprises a resistor 20 having a first end 14 and a second end 30 with the first end 14 connected to a positive voltage such as Vcc. The second end 30 is connected to node C. The sensor 60 further comprises a capacitor 40 with a first end connected to node 30 and a second end connected to ground.

In the operation of the temperature sensor 60, the first end 14 is connected to Vcc and the second end of the capacitor 40 is connected to ground. The microcontroller pin C or second end 30 is configured as an output and driven low long enough to discharge the capacitor 40. Then the microcontroller pin C is reconfigured to an input with a fixed voltage threshold. The capacitor begins to charge through resistor 20 while the microcontroller 12 monitors how long it takes to reach a fixed threshold. The time it takes for the capacitor 40 to charge to the fixed threshold is dependent on capacitance of the capacitor 40, which is dependent on temperature. This is similar to that discussed for the detection of RF radiation shown in FIG. 2, except the time to charge to the threshold is measured here and the time to discharge to the threshold is measured in FIG. 2.

An exemplary graph of the capacitance—temperature dependency can be seen by reference to FIG. 4. In FIG. 4 a graph of the capacitance of the capacitor 40 as a function of the ambient temperature is shown. If the ambient temperature is, for example 70 degrees F., then the capacitance is higher than if the ambient temperature were at 95 degrees F. This difference in the capacitance indirectly measured at node C can be used to adjust the sensitivity of the associated infrared sensor 80, shown in FIG. 3. Thus, if the microcontroller 12 determines that the ambient temperature is sufficiently different than human body temperature (example 70 degrees F.), it can then adjust the sensitivity of the infrared sensor 80 accordingly. Thus, in the event the ambient temperature as measured by the sensor 60 approaches human body temperature, the sensitivity of the infrared sensor 80 can be increased to increase the sensitivity of detection. As the ambient temperature becomes increasingly different than human skin temperature, the sensitivity of the infrared sensor 80 can be decreased to decrease the possibility of false alarm. This dynamic adjustment of the sensitivity of the infrared sensor 80 provides greater flexibility in detection.

A typical capacitor 40 that can be used has a dielectric type Y5V. Such a capacitor 40 can change its capacitance of about 15% between 70 degrees F. and 95 degrees F., which results in a significant, and easily resolvable, change in time to reach threshold.

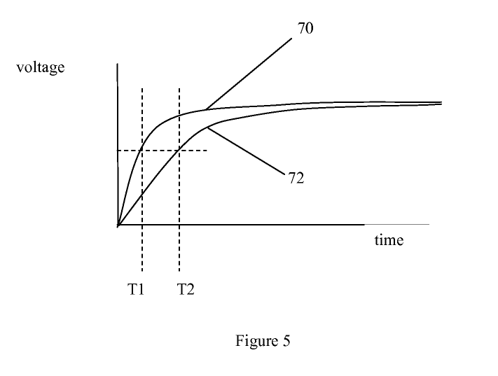

Referring to FIG. 5, there is shown a graph of voltage versus time with regard to the temperature sensor 60. in this mode of operation the temperature sensor 60 relies on the change in capacitance of capacitor 40 versus temperature of the capacitor 40, typically of the Y5V dielectric type. However, it should be noted as discussed previously that other types of capacitor may also be used. The microcontroller 12 measures the capacitance indirectly by measuring the time it takes the RC circuit to charge to a given threshold through the resistor 20 after the capacitor 40 has been discharged by the microcontroller 12. The steps to determine the temperature is as follows:

Step 1. Discharge capacitor 40 by setting the pin C low.

Step 2. Change the pin C from an output to an input under software control. If it is a digital input it will have a fixed threshold. If it is an analog input (A/D) converter the input will be read by software and compared to a threshold.

Step 3. Measure the time it takes for the capacitor 40 to charge to the threshold.

Step 4. Determine the temperature based on the time. This can be done with a lookup table or algorithm. The microprocessor 12 can also hold unique calibration factors to compensate for variability in the capacitor 40 if there is a need for higher accuracy.

FIG. 5 represents the two Voltage versus time curves that might be expected for the capacitance of the capacitor 40 shown in FIG. 4 at two different temperatures. In the first case, the temperature is at 70 F the capacitor 40 will take longer to charge due to the higher capacitance. This corresponds to graph 72 and the T2 time in FIG. 5. The second case, the temperature is higher (95 F), with the capacitor 40 having a lower capacitance. Thus, T1 in FIG. 5 corresponds to this higher ambient temperature with lower capacitance in the capacitor 40. The curves in FIG. 5 are charge curves instead of discharge curves—that's why they are inverted compared to FIG. 2. The RF detector diode method of FIG. 1 operates in a similar fashion to the temperature sensor 60 but measures the time it takes the diode current to discharge rather than charge its capacitor 40. The temperature sensor 60 could also be done the same way by taking the resistor 20 to ground instead of Vcc, and then briefly charging the capacitor 40 before measuring the time it takes to discharge to a fixed threshold. Whichever way it is done it relies on capacitance versus temperature of an inexpensive capacitor.

From the foregoing, it can be seen that a simple and elegant RF detector and ambient temperature sensor are disclosed. These detector and sensor can increase the sensitivity of detection and decrease the possible incidents of false alarm.

What is claimed is:

1. An RF electromagnetic radiation detector comprising:
a device having a first terminal and a second terminal with a PN junction therebetween, with the first terminal connected to the P side of the PN junction and the second terminal connected to the N side of the PN junction, with the device susceptible to a voltage being built across the PN junction in the presence of RF electromagnetic radiation;
means for connecting a first voltage to the first terminal and a second voltage to the second terminal; and
means for measuring the current from the second terminal, wherein the current measured is indicative of the presence of RF electromagnetic radiation.

2. The detector of claim 1 further comprising:
a load connected between the first terminal and the first voltage.

3. The detector of claim 1 further comprising:
a capacitor connected between the second terminal and a third voltage.

4. The detector of claim 3 wherein said third voltage is ground.

5. The detector of claim 1 wherein said second voltage is higher than said first voltage.

6. The detector of claim 1 wherein said means for measuring the current includes measuring the time for the current measured to reach a target value, and wherein the time measured is indicative of the presence of RF electromagnetic radiation.

7. A method of detecting RF electromagnetic radiation in an intrusion detection device having a first terminal and a second terminal with a PN junction therebetween, with the first terminal connected to the P side of the PN junction and the second terminal connected to the N side of the PN junction, with the device susceptible to a voltage being built across the PN junction in the presence of RF electromagnetic radiation; wherein said methods comprising:
reverse biasing the device by connecting a first voltage to the first terminal and a second voltage, higher than the first voltage to the second terminal; and
measuring the current from the second terminal, wherein the current measured is indicative of the presence of RF electromagnetic radiation.

8. The method of claim 7 wherein said measuring step further comprises:
measuring the current flow after a period of time; and
comparing the current measured to a pre-determined amount to determine the presence of RF electromagnetic radiation.

9. The method of claim 7 wherein said measuring step further comprises:
measuring the current flow until a pre-determined amount is reached; and
measuring the amount of time to reach said pre-determined amount; and
comparing the amount of time measured to a pre-determined amount of time to determine the presence of RF electromagnetic radiation.
